(19) United States
(12) Patent Application Publication
(10) Pub. No.: US 2013/0063428 A1
(43) Pub. Date: Mar. 14, 2013

(54) METHOD OF DISPLAYING AN IMAGE AND DISPLAY APPARATUS FOR PERFORMING THE SAME

(71) Applicants: Hak-Mo CHOI, Seoul (KR); Tae-Kwon Jung, Seongnam-si (KR); Min-Kyu Park, Cheonan-si (KR); Kwan-Young Oh, Seoul (KR)

(72) Inventors: Hak-Mo CHOI, Seoul (KR); Tae-Kwon Jung, Seongnam-si (KR); Min-Kyu Park, Cheonan-si (KR); Kwan-Young Oh, Seoul (KR)

(21) Appl. No.: 13/606,165

(22) Filed: Sep. 7, 2012

(30) Foreign Application Priority Data
Sep. 8, 2011 (KR) 10-2011-0091264

(51) Int. Cl. G06T 15/50

(52) U.S. Cl. 345/419

(57) ABSTRACT

A method of displaying an image, the method includes providing a source data frame and at least one copy data frame repeating the source data frame to a display panel and, selectively providing boosted light of a first luminance level to the display panel during a first period and normal light of a second luminance level to the display panel during a second period, based on the source data frame and the copy data frame, the second luminance level being smaller than the first luminance level, the second period being longer than the first period.

### CROSS-REFERENCE TO RELATED APPLICATION

This application claims priority under 35 U.S.C. §119 to Korean Patent Application No. 10-2011-0091264, filed on Sep. 8, 2011 in the Korean Intellectual Property Office (KIPO), the contents of which are herein incorporated by reference in their entireties.

### TECHNICAL FIELD

Exemplary embodiments of the present invention relate to a method of displaying an image and a display apparatus for performing the method. More particularly, exemplary embodiments of the present invention relate to a method of displaying an image for decreasing power consumption and a display apparatus for performing the method.

### DISCUSSION OF THE RELATED ART

Generally, liquid crystal displays (“LCDs”) display two-dimensional (“2D”) images. LCDs that display three-dimensional (“3D”) images have been developed with increasing demand for 3D images in various industrial fields, such as games, movies and so on.

A 3D image display apparatus displays 3D images using binocular parallax through two eyes of a human. For example, since two eyes of an observer are spaced apart from each other, images viewed at the different angles are inputted to his/her brain. As a consequence, the observer may recognize a stereoscopic image through the display apparatus.

Stereoscopic image display apparatuses may be classified into a stereoscopic type with an extra spectacle and an auto-stereoscopic type without an extra spectacle. The stereoscopic type employs a passive polarized glasses method using polarized filters having different polarized axes for both eyes or an active shutter glasses method. In the active shutter glasses method, a left-eye image and a right-eye image are time-divided and periodically displayed, and a pair of glasses sequentially open or close a left-eye shutter and a right-eye shutter in synchronization with the periods.

The active shutter glasses method drives an LCD panel with a relatively high frequency of more than about 60 Hz. For driving the LCD panel at a relatively high frequency, a motion estimation and motion compensation (“MEMC”) circuit is used. The MEMC circuit generates an interpolation frame image to be inserted between a previous frame image and a present frame image using an MEMC algorithm so that the LCD panel is driven with the high frequency.

A method of displaying 3D stereoscopic images includes a scanning driving method. The scanning driving method drives a backlight unit based on an LC response time of the LCD panel to address a motion blur which may occur in the LCD panel. However, the scanning driving method decreases the luminance of a 3D stereoscopic image. To address the motion blur, a luminance boosting method is used, but the luminance boosting method provides a high voltage to the backlight unit during a short period, increasing power consumption.

### SUMMARY

Exemplary embodiments of the present invention provide a method of displaying an image that can decrease power consumption and improve display quality, and a display apparatus performing the method.

According to an exemplary embodiment of the invention, there is provided a method of displaying an image, the method includes providing a source data frame and at least one copy data frame repeating the source data frame to a display panel and, selectively providing boosted light of a first luminance level to the display panel during a first period and normal light of a second luminance level to the display panel during a second period, based on the source data frame and the copy data frame, the second luminance level being smaller than the first luminance level, the second period being longer than the first period.

In an exemplary embodiment, when the source data frame is the same or substantially the same as a previous source data frame received during a previous period, the first and second luminance levels are the same or substantially the same as luminance levels of previous boosted light and previous normal light provided to the display panel when an image corresponding to the previous source data frame is displayed on the display panel.

In an exemplary embodiment, selectively providing the boosted light and the normal light includes providing the boosted light to the display panel when a data voltage of the source data frame is charged in the display panel, and providing the normal light to the display panel when a data voltage of the at least one copy data frame is charged in the display panel.

In an exemplary embodiment, the method further includes generating an interpolation data frame using a motion estimation and motion compensation (“MEMC”) algorithm based on the source data frame, when the source data frame is two-dimensional (“2D”) image data, repeating each of the source data frame and the interpolation data frame and outputting the source data frame, at least one first copy data frame repeating the source data frame, the interpolation data frame and at least one second copy data frame repeating the interpolation data frame, providing the boosted light to the display panel when a data voltage of the source data frame or the interpolation data frame is charged in the display panel, and providing the normal light to the display panel when a data voltage of the first copy data frame or the second copy data frame is charged in the display panel.

In an exemplary embodiment, the method further includes repeating each of left-eye and right-eye source data frames and outputting the left-eye source data frame, at least one left-eye copy data frame repeating the left-eye source data frame, the right-eye source data frame and at least one the right-eye copy data frame repeating the right-eye source data frame, when the source data frame is three-dimensional (“3D”) image data including the left-eye and right-eye source data frames, providing the boosted light to the display panel when a data voltage of the left-eye data frame or the right-eye source data frame is charged in the display panel, and providing the normal light to the display panel when a data voltage of the left-eye data frame or the right-eye copy data frame is charged in the display panel.

In an exemplary embodiment, the method further includes inserting a black data frame between the left-eye copy data frame and the right-eye source data frame, and inserting the black data frame between the right-eye copy data frame and the light-eye source data frame.

In an exemplary embodiment, the method further includes blocking light from being provided to the display panel when a data voltage of the black data frame is charged in the display panel.

In an exemplary embodiment, the method further includes sequentially providing a plurality of block light to a plurality of display blocks of the display panel, the block light being generated from a plurality of light-emitting blocks corresponding to the display blocks, wherein a light-emitting block of the plurality of light-emitting blocks corresponding to a display block of the plurality of display blocks generates the boosted light when a data voltage of the source data frame is charged in the display block and generates the normal light when a data voltage of the copy data frame is charged in the display block.

In an exemplary embodiment, the first period is determined based on a response rate of the display panel.

In an exemplary embodiment, a luminance level of the display panel which is provided with the boosted light during the first period is the same or substantially the same as a luminance level of the display panel which is provided with the normal light during the second period.

According to an exemplary embodiment of the invention, there is provided a display apparatus. The display apparatus includes a display panel, a main driving part providing a source data frame and at least one copy data frame repeating the source data frame to the display panel, and a light source part selectively providing boosted light of a first luminance level to the display panel during a first period and normal light of a second luminance level to the display panel during a second period, based on the source data frame and the copy data frame, the second luminance level being smaller than the first luminance level, the second period being longer than the first period.

In an exemplary embodiment, the main driving part includes a repeating part repeating the source data frame and outputting at least one copy data frame, and a light luminance control part providing the boosted light to the display panel when a data voltage of the source data frame is charged in the display panel, and providing the normal light to the display panel when a data voltage of the at least one copy data frame is charged in the display panel

In an exemplary embodiment, when source data frame is the same or substantially the same as a previous source data frame received during a previous period, the light luminance control part provides the boosted light of the first luminance level and the normal light of the second luminance level to the display panel wherein the first and second luminance levels are the same or substantially the same as luminance levels of previous boosted light and previous normal light provided to the display panel when an image corresponding to the previous source data frame is displayed on the display panel.

In an exemplary embodiment, the main driving part further comprises an interpolating part generating an interpolation data frame using an MEMC algorithm based on the source data frame, wherein the repeating part repeats each of the source data frame and the interpolation data frame and outputs the source data frame, at least one first copy data frame repeating the source data frame, the interpolation data frame, and at least one second copy data frame repeating the interpolation data frame, and the light luminance control part provides the boosted light to the display panel when a data voltage of the source data frame or the interpolation data frame is charged in the display panel, and provides the normal light to the display panel when a data voltage of the first copy data frame or the second copy data frame is charged in the display panel.

In an exemplary embodiment, the main driving part further includes a 3D processing part processing the source data frame and outputting a left-eye source data frame and a right-eye source data frame, the repeating part repeats each of the left-eye and right-eye source data frames and outputs the left-eye source data frame, at least one left-eye copy data frame repeating the left-eye source data frame, the right-eye source data frame and at least one the right-eye source data frame repeating the right-eye source data frame, and the light luminance control part provides the boosted light to the display panel when a data voltage of the left-eye data frame or the right-eye source data frame is charged in the display panel, and provides the normal light to the display panel when a data voltage of the left-eye data frame or the right-eye copy data frame is charged in the display panel.

In an exemplary embodiment, the main driving part further includes a black inserting part inserting a black data frame between the left-eye copy data frame and the right-eye source data frame, and inserting the black data frame between the right-eye copy data frame and the light-eye source data frame.

In an exemplary embodiment, the light luminance control part controls the light source part to block light from being provided to the display panel when a data voltage of the black data frame is charged in the display panel.

In an exemplary embodiment, the light source part includes a plurality of light-emitting blocks corresponding to a plurality of display blocks included in the display panel, and the light-emitting blocks sequentially provide a plurality of block light to the display blocks, and a light-emitting block of the plurality of light-emitting blocks corresponding to a display block of the plurality of display blocks generates the boosted light when a data voltage of the source data frame is charged in the display block and generates the normal light when a data voltage of the copy data frame is charged in the display block.

In an exemplary embodiment, the light luminance control part determines the second period and the second luminance level, so that a luminance level of the display panel which is provided with the boosted light during the first period is the same or substantially the same as a luminance level of the display panel which is provided with the normal light during the second period.

According to the embodiments of the present invention, boosted light which increases power consumption is provided during the charging period during which the source data frame is charged in the display panel, and normal light which decreases power consumption is provided during the holding period during which the copy data frame is charged in the display panel. As a consequence, the power consumption of the display apparatus is decreased.

In the 3D image mode, boosted light is provided to the display panel based on the LC response rate during a period during which the data voltage of the left-eye or right-eye data frame is completely charged in the display panel, so that crosstalk mixing the left-eye and right-eye images with each other may be prevented.

### BRIEF DESCRIPTION OF THE DRAWINGS

The embodiments of the present invention will become more apparent by describing detailed descriptions thereof with reference to the accompanying drawings, in which:

FIG. 1 is a block diagram illustrating a display apparatus according to an exemplary embodiment of the present;

FIG. 2 is a timing diagram illustrating driving signals for describing a method of displaying a 2D image using the display apparatus of FIG. 1;

FIG. 3 is a timing diagram illustrating driving signals for describing a method of displaying a 2D image using a display apparatus according to an exemplary embodiment of the present;

FIG. 4 is a timing diagram illustrating driving signals for describing a method of displaying a 3D image using a display apparatus according to an exemplary embodiment of the present;

FIG. 5 is a timing diagram illustrating driving signals for describing a method of displaying a 3D image using a display apparatus according to an exemplary embodiment of the present; and

FIG. 6 is a timing diagram illustrating driving signals for describing a method of displaying a 3D image using a display apparatus according to an exemplary embodiment of the present.

### DETAILED DESCRIPTION

Hereinafter, the embodiments of the present invention will be described in detail with reference to the accompanying drawings. However, the present invention may be embodied in various different ways and should not be construed as limited to the exemplary embodiments described herein.

As used herein, the singular forms, “a,” “an” and “the” are intended to include the plural forms as well, unless the context clearly indicates otherwise.

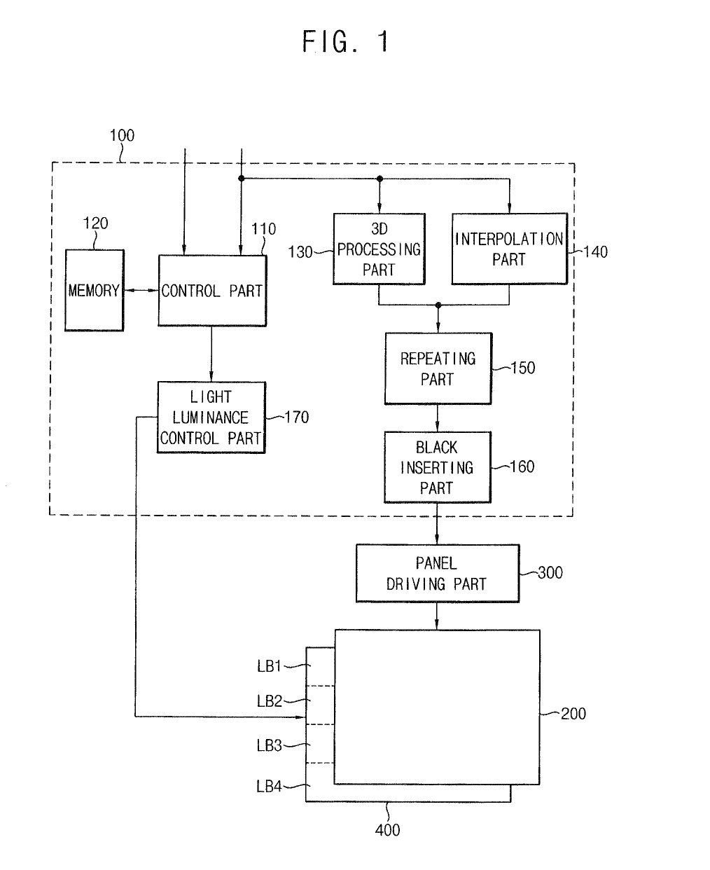

FIG. 1 is a block diagram illustrating a display apparatus according to an exemplary embodiment of the present.

Referring to FIG. 1, the display apparatus includes a main driving part 100, a display panel 200, a panel driving part 300 and a light source part 400.

The main driving part 100 includes a control part 110, a memory 120, a three-dimensional (3D) processing part 130, an interpolating part 140, a repeating part 150, a black inserting part 160 and a light luminance control part 170.

The control part 110 receives a control signal including a 3D enable signal and a synchronization signal, and source data. The control part 110 controls the main driving part 100 based on the control signal. For example, when the 3D enable signal has a high level, the control part 110 controls the main driving part 100 so that the main driving part 100 drives the display apparatus in a 3D image mode displaying a 3D image. When the 3D enable signal has a low level, the control part 110 controls the main driving part 100 so that the main driving part 100 drives the display apparatus in a two-dimensional (2D)image mode displaying a 2D image.

The memory 120 stores the source data. The memory 120 stores the source data on a per-frame basis, on a per-field basis, or on a per-line basis.

The 3D processing part 130 process the received source data into 3D image data in a 3D image mode. The 3D processing part 130 divides the source data into left-eye source data and right-eye source data, and scales the left-eye and right-eye source data into left-eye and right-eye source data frames, respectively, corresponding to a resolution of the display panel 300. The 3D processing part 130 sequentially outputs the left-eye source data frame and the right-eye source data frame.

The interpolating part 140 generates an interpolation data frame corresponding to a present source data frame and a previous source data frame using a motion estimation and motion compensation (MEMC) algorithm. For example, the MEMC algorithm estimates an interpolation motion vector using a present motion vector corresponding to the present source data frame and a previous motion vector corresponding to the previous source data frame, and generates the interpolation data frame using the interpolation motion vector. As a consequence, the interpolating part 140 sequentially outputs the interpolation data frame and a present source data frame.

The repeating part 150 repeats, at least once, a data frame received from the interpolating part 140 based on a panel driving frequency according to control of the control part 110.

For example, in a 2D image mode with the panel driving frequency of about 240 Hz, the repeating part 150 repeats each of the interpolation data frame and the source data frame once, and outputs the interpolation data frame, a first copy data frame repeating the interpolation data frame once, the source data frame, and a second copy data frame repeating the source data frame once. In the 2D image mode with the panel driving frequency of about 360 Hz, the repeating part 150 repeats each of the interpolation data frame and the source data frame two times, and outputs the interpolation data frame, two first copy data frames repeating the interpolation data frame two times, the source data frame, and two second copy data frames repeating the source data frame two times.

In the 3D image mode with the driving frequency of about 360 Hz, the repeating part 150 repeats each of the left-eye source data frame and the right-eye source data frame two times, and outputs the left-eye source data frame, two left-eye copy data frames repeating the left-eye source data frame two times, the right-eye source data frame, and two right-eye copy data frames repeating the right-eye source data frame two times. In the 3D image mode with the display panel driving frequency of about 480 Hz, the repeating part 150 repeats each of the left-eye source data frame and the right-eye source data frame three times, and outputs the left-eye source data frame, three left-eye copy data frames repeating the left-eye source data frame three times, the right-eye source data frame, and three right-eye copy data frames repeating the right-eye source data frame three times.

The black inserting part 160 inserts a black data frame between the left-eye data frame and the right-eye data frame, so that crosstalk mixing a left-eye image and a right-eye image may be decreased in the 3D image mode. For example, in the 3D image mode of about 360 Hz, the black inserting part 160 receives the left-eye source data frame, two left-eye copy data frames, the right-eye source data frame and two right-eye copy data frames. The black inserting part 160 outputs the left-eye source data frame, a first left-eye copy data frame, the black data frame instead of a second left-eye copy data frame, the right-eye source data frame, a first right-eye copy data frame and the black data frame instead of a second right-eye copy data frame. According to an embodiment, the black inserting part 160 is omitted according to a processing method of the 3D image mode.

However, the black inserting part 160 bypasses data frames received from the repeating part 150 in the panel driving part 300 in the 2D image mode.

The light luminance control part 170 controls a luminance level of light generated from the light source part 400 based on a data frame provided to the display panel 200 according to control of the control part 110. For example, the light luminance control part 170 controls the luminance level of light generated from the light source part 400 according to a local dimming method or a global dimming method. According to the local dimming method, the light source part 400 includes a plurality of light-emitting blocks corresponding to a plurality of display blocks of the display panel 200. The light-emitting blocks are individually driven. The light luminance control part 170 determines the luminance level of a light-emitting block corresponding to a display block of the display panel 200 based on block data which are provided to the display block. As a consequence, the light source part 400 includes the light-emitting blocks which generate a plurality of block light having a plurality of luminance levels based on a luminance distribution of a frame image displayed on the display panel 200.

According to an exemplary embodiment, the light luminance control part 170 drives the light source part 200 in a boosting driving mode or a normal driving mode based on the data frame which is provided to the display panel 200. The light source part 400 receives a relatively high voltage during a relatively short period in the boosting driving mode, and receives a relatively low voltage during a relatively long period in the normal driving mode.

For example, in the 2D image mode, the light luminance control part 170 controls the light source part 400 to generate boosted light having a first luminance level during a first period of a frame during which the source data frame or the interpolation data frame is provided to the display panel 200, and to generate normal light having a second luminance level less than the first luminance level during a second period of the frame during which the first copy data frame or the second copy data frame is provided to the display panel 200.

In the 3D image mode, the light luminance control part 170 controls the light source part 400 to generate boosted light having a first luminance level during a first period of a frame during which the left-eye source data frame or the right-eye source data frame is provided to the display panel 200, and to generate normal light having a second luminance level less than the first luminance level during a second period of the frame during which the left-eye copy data frame or the right-eye copy data frame is provided to the display panel 200. The light luminance control part 170 controls the light source part 400 to block light from being provided to the display panel 200 during a period during which the black data frame is provided to the display panel 200. The second period is determined variously in at least one frame in which a copy data frame outputted from the repeating part 150 is provided to the display panel 200. The light luminance control part 170 determines the second period and the second luminance level, so that a luminance level of the display panel 200 receiving the boosted light during the first period is the same or substantially the same as a luminance level of the display panel 200 receiving the normal light during the second period. As a consequence, the first period during which the light source part 400 is driven in the boosting driving mode is decreased so that the power consumption may be decreased.

The light luminance control part 170 compares a present source data frame presently received with a previous source data frame previously received, and determines whether the present source data frame is a static image. When the present source data frame is the same or substantially the same as a previous source data frame, the light luminance control part 170 determines that the present source data frame is a static image, and determines that luminance levels of the light source part 400 corresponding to the present source data frame are the same or substantially the same luminance levels as luminance levels of the light source part 400 corresponding to the previous source data frame. Therefore, when the static image is displayed on the display panel 200, a flicker may be prevented from occurring by a luminance difference between the sequential frame images. However, when the present source data frame is different from the previous source data frame, the light luminance control part 170 determines that the present source data frame is a moving image, and determines luminance levels of the light source part 400 corresponding to the present source data frame.

The display panel 200 includes a plurality of gate lines GL, a plurality of data lines DL and a plurality of pixels P. The gate lines GL are extended along a first direction D1 and arranged along a second direction crossing the first direction D1. The data lines DL are extended along the second direction D2 and arranged along the first direction D1. Each pixel P includes a switching element TR connected to a gate line GL and a data line DL, a liquid crystal capacitor CLC connected to the switching element TR and a storage capacitor CST.

The panel driving part 300 displays the data frame received from the repeating part 150 on the display panel 200. The panel driving part 300 includes a gate driving part sequentially providing a plurality of gate signals to the gate lines GL and a data driving part providing a plurality of data signals to the data lines DL.

The light source part 400 includes a light source driving part (not shown) and a light source (not shown). The light source driving part generates a driving signal based on the control of the light luminance control part 170 and outputs the driving signal to the light source. The light source is arranged in, for example, a direct-illumination type or an edge-illumination type. The light source part 400 of the edge-illumination type includes a light guide plate (LGP) disposed under the display panel 200 and at least one light source disposed at an edge portion of the LGP. The light source part 400 of the direct-illumination type includes at least one light source directly disposed under the display panel 200 without an LGP.

The light source part 400 includes at least one light-emitting block which is individually driven. For example, according to an embodiment, the light source part 400 includes a plurality of light-emitting blocks which are sequentially driven along an image scanning direction of the display panel 200. The image scanning direction is the same or substantially the same as the second direction D2. For example, the light source part 400 includes a first light-emitting block LB1, a second light-emitting block LB2, a third light-emitting block LB3 and a fourth light-emitting block LB4 which are sequentially driven along the image scanning direction D2. According to an embodiment, the number of the light-emitting blocks may vary.

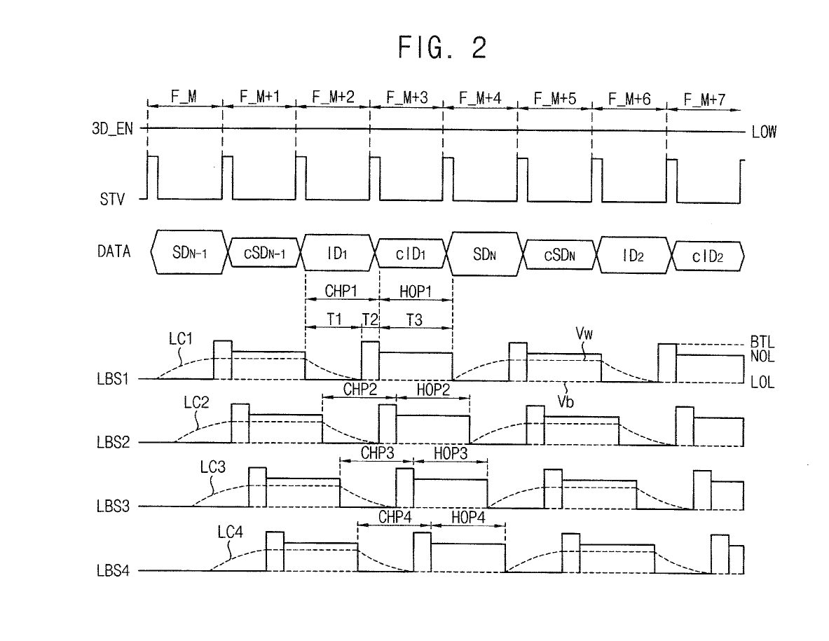

FIG. 2 is a timing diagram illustrating driving signals for describing a method of displaying a 2D image using the display apparatus of FIG. 1.

Hereinafter, the same reference numerals may be used to refer to the same or similar parts throughout the specification and the drawings.

Referring to FIGS. 1 and 2, a method of displaying a 2D image with a panel driving frequency of about 240 Hz will be explained.

The control part 110 receives a 3D enable signal 3D_EN of a low level LOW and controls the main driving part 100 to process an operation of the display apparatus in a 2D image mode.

For example, the interpolating part 140 generates an interpolation data frame ID1 using source image data stored in the memory 120 and the source image data received, based on the MEMC algorithm. The interpolating part 140 sequentially outputs the interpolation data frame ID1 and the source data frame SDN.

The repeating part 150 repeats the interpolation data frame ID1 and outputs the interpolation data frame ID1 and a first copy data frame cID1 repeating the interpolation data frame ID1, and repeats the source data frame SDN and outputs the source data frame SDN and a second copy data frame cSDN repeating the source data frame SDN. According to an exemplary embodiment, the interpolation data frame ID1 is referred to as the black data frame including black grayscale data corresponding to a black voltage Vb, and the source data frame SDN is referred to as a white data frame including white grayscale data corresponding to a white voltage Vw.

In the 2D image mode, the black inserting part 160 bypasses the interpolation data frame ID1, the first copy data frame cID1, the source data frame SDN and the second copy data frame cSDN which are received from the repeating part 150 to the panel driving part 300.

The panel driving part 300 provides the interpolation data frame ID1, the first copy data frame cID1, the source data frame SDN and the second copy data frame cSDN to the display panel 200, based on a vertical stating signal STV with a panel driving frequency of about 240 Hz.

As shown in FIG. 2, the panel driving part 300 provides the interpolation data frame ID1 to the display panel 200 during an (M+2)-th frame F_M+2, provides the first copy data frame cID1 to the display panel 200 during an (M+3)-th frame F_M+3, provides the source data frame SDN to the display panel 200 during an (M+4)-th frame F_M+4, and provides the second copy data frame cSDN to the display panel 200 during an (M+5)-th frame F_M+5.

For example, the (M+2)-th frame F_M+2 is a charging period during which a data voltage of the interpolation data frame ID1 is charged in the display panel 200. The (M+3)-th frame F_M+3 is a period during which a data voltage of the first copy data frame cID1 is charged in the display panel 200, for example, the (M+3)-th frame F_M+3 is a holding period during which the data voltage of the interpolation data frame ID1 charged in the display panel 200 is held.

The (M+4)-th frame F_M+4 is a charging period during which a data voltage of the source data frame SDN is charged in the display panel 200. The (M+5)-th frame F_M+5 is a period during which a data voltage of the second copy data frame cSDN is charged in the display panel 200, for example, the (M+5)-th frame F_M+5 is a holding period during which the data voltage of the source data frame SDN charged in the display panel 200 is held.

The light luminance control part 170 provides a boosting signal to the light source part 400 during the charging period during which the data voltage of the interpolation data frame ID1 is charged in the display panel 200, and provides a normal signal to the light source part 400 during the holding period during which the data voltage of the first copy data frame cID1 is charged in the display panel 200. The light luminance control part 170 provides the boosting signal to the light source part 400 during the charging period during which the data voltage of the source data frame SDN is charged in the display panel 200, and provides the normal signal to the light source part 400 during the holding period during which the data voltage of the second copy data frame cSDN is charged in the display panel 200. The boosting signal has the low level LOL and blocks light from the display panel 200 during a first period T1 of the charging period, and has a boosting level BTL during a second period T2 of the charging period. The normal signal has a normal level NOL during a third period T3 of the holding period.

The light luminance control part 170 generates the normal signal based on the boosting signal. A luminance level of boosted light generated from the light source part 400 based on the boosting signal during the charging period is the same or substantially the same as a luminance level of the normal light generated from the light source part 400 based on the normal signal during the holding period. As a consequence, a luminance difference between images displayed during the frames adjacent to each other may be prevented, and a driving voltage having the normal level NOL based on the normal signal is applied to the light source part 400 during the holding period so that power consumption may be decreased.

However, when the source data frame SDN received during a present period is the same or substantially the same as the source data frame SDN-1 received during a previous period, the light luminance control part 170 determines that the source data frame SDN is a static image, and determines that levels of the boosting and normal signals corresponding to the source data frame SDN are the same or substantially the same as levels of the boosting and normal signals corresponding to the source data frame SDN-1. Therefore, when the static image is displayed on the display panel 200, a flicker may be prevented from occurring by a luminance difference between the sequential frame images.

According to an exemplary embodiment, the light source part 400 includes a first light-emitting block LB1, a second light-emitting block LB2, a third light-emitting block LB3 and a fourth light-emitting block LB4.

The first light-emitting block LB1 provides first block light to a first display block of the display panel 200 opposite to the first light-emitting block LB1, provides second block light to a second display block of the display panel 200 opposite to the second light-emitting block LB2, provides third block light to a third display block of the display panel 200 opposite to the third light-emitting block LB3, and provides fourth block light to a fourth display block of the display panel 200 opposite to the fourth light-emitting block LB4.

The light luminance control part 170 generates first, second, third and fourth driving signals LBS1, LBS2, LBS3 and LBS4 respectively based on liquid crystal (LC) response rates LC1, LC2, LC3 and LC4 of first, second, third and fourth display blocks included in the display panel 200 and provides the first, second, third and fourth driving signals LBS1, LBS2, LBS3 and LBS4 to the first, second, third and fourth light-emitting blocks LB1, LB2, LB3 and LB4, respectively.

Referring to the first driving signal LBS1, the first driving signal LBS1 has the boosting signal during a first charging period CHP1 during which the interpolation data frame ID1 or the source data frame SDN is charged in the first display block, and has the normal signal during a first holding period HOPI during which the first copy data frame c1D1 or the second copy data frame cSDN is charged in the first display block. The boosting signal has the low level LOL during the first period T1 of the first charging period CHP1 during which a first LC response rate LC1 is less than a threshold value, and the boosting level BTL during the second period T2 of the first charging period CHP1 during which the first LC response rate LC1 is more than or the same as the threshold value. The normal signal has the normal level NOL during the third period T3 of the first holding period HOP1.

A luminance level of boosted light generated from the first light-emitting block LB1 based on the boosting signal is the same or substantially the same as a luminance level of the normal light generated from the first light-emitting block LB1 based on the normal signal. As a consequence, the boosting level BTL and the second period T2 are adjusted based on the normal level NOL and the third period T3. The normal level NOL and the third period T3 are adjusted based on the he boosting level BTL and the second period T2. The third period T3 is equal to or less than the first holding period HOP1.

As described above, the second driving signal LBS2 has the low level LOL during the first period T1 of a second charging period CHP2 during which the interpolation data frame ID1 or the source data frame SDN is charged in the second display block, and has the boosting level BTL during the second period T2 of the second charging period CHP2. The second driving signal LBS2 has the normal level NOL during a second holding period HOP2 during which the first copy data frame cID1 or the second copy data frame cSDN is charged in the second display block.

The third driving signal LBS3 has the low level LOL during the first period T1 of a third charging period CHP3 during which the interpolation data frame ID1 or the source data frame SDN is charged in the third display block and has the boosting level BTL during the second period T2 of the third charging period CHP3. The third driving signal LBS3 has the normal level NOL during a third holding period HOP3 during which the first copy data frame cID1 or the second copy data frame cSDN is charged in the third display block.

The fourth driving signal LBS4 has the low level LOL during the first period T1 of a fourth charging period CHP4 during which the interpolation data frame ID1 or the source data frame SDN is charged in the fourth display block, and has the boosting level BTL during the second period T2 of the fourth charging period CHP4. The fourth driving signal LBS4 has the normal level NOL during a fourth holding period HOP4 during which the first copy data frame cID1 or the second copy data frame cSDN is charged in the fourth display block.

Therefore, the light source part 400 provides the boosted light corresponding to a boosting luminance to the display panel 200 based on the LC response rate during the charging period during which the source data frame or the interpolation data frame is completely charged in the display panel 200, and provides the normal light corresponding to a normal luminance to the display panel 200 during the holding period during which the copy data frame repeated from the repeating part 150 is charged in the display panel 200.

According to an exemplary embodiment, the boosted light which increases the power consumption is provided during the charging period during which the source data frame is completely charged in the display panel 200, and the normal light which decreases the power consumption is provided during the holding period during which the copy data frame is charged in the display panel 200. As a consequence, the power consumption of the display apparatus may be decreased.

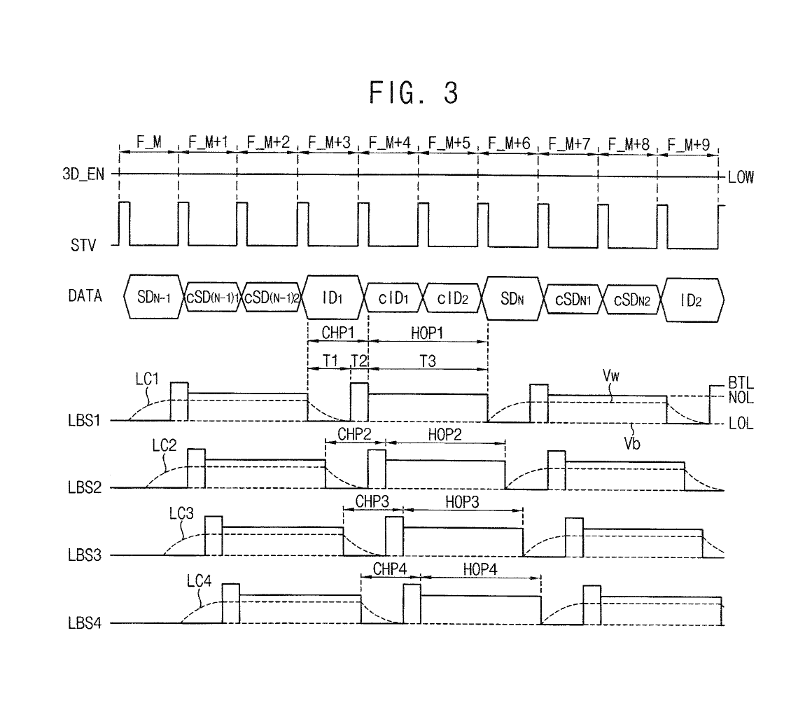

FIG. 3 is a timing diagram illustrating driving signals for describing a method of displaying a 2D image using a display apparatus according to an exemplary embodiment of the present invention.

Referring to FIGS. 1 and 3, a method of displaying a 2D image with a panel driving frequency of about 360 Hz is described.

The control part 110 receives the 3D enable signal 3D_EN of the low level LOW and controls the main driving part 100 to process an operation of the display apparatus in the 2D image mode.

For example, the interpolating part 140 generates an interpolation data frame ID1 using a source image data stored in the memory 120 and the source image data received, based on the MEMC algorithm. The interpolating part 140 sequentially outputs the interpolation data frame ID1 and the source data frame SDN.

The repeating part 150 repeats the interpolation data frame ID 1 two times and outputs the interpolation data frame ID1 and two first copy data frames cID1 and cID2, and repeats the source data frame SDN two times and outputs the source data frame SDN and two second copy data frames cSDN1 and cSDN2.

In the 2D image mode, the black inserting part 160 bypasses the interpolation data frame ID1, two first copy data frames cID1 and cID2, the source data frame SDN and two second copy data frames cSDN1 and cSDN2 received from the repeating part 150 to the panel driving part 300.

The panel driving part 300 provides the interpolation data frame ID1, two first copy data frames cID1 and cID2, the source data frame SDN and two second copy data frames cSDN1 and cSDN2 to the display panel 200 based on the vertical stating signal STV with a panel driving frequency of about 360 Hz.

As shown in FIG. 3, the panel driving part 300 provides the interpolation data frame ID1 to the display panel 200 during an (M+3)-th frame F_M+3, provides two first copy data frames cID1 and cID2 to the display panel 200 during an (M+4)-th frame F_M+4 and an (M+5)-th frame F_M+5, provides the source data frame SDN to the display panel 200 during an (M+6)-th frame F_M+6, and provides two second copy data frames cSDN1 and cSDN2 to the display panel 200 during an (M+7)-th frame F_M+7 and an (M+8)-th frame F_M+8.

For example, the (M+3)-th frame F_M+3 is a charging period during which a data voltage of the interpolation data frame ID1 is charged in the display panel 200. The (M+4)-th and (M+5)-th frames F_M+4 and F_M+5 are periods during which data voltages of two first copy data frames cID1 and cID2 are charged in the display panel 200, for example, the (M+4)-th and (M+5)-th frames F_M+4 and F_M+5 are holding periods during which the data voltage of the interpolation data frame ID1 charged in the display panel 200 is held.

The (M+6)-th frame F_M+6 is a charging period during which a data voltage of the source data frame SDN is charged in the display panel 200. The (M+7)-th frame F_M+7 and the (M+8)-th frame F_M+8 are periods during which data voltages of the second copy data frames cSDN1 and cSDN2 are charged in the display panel 200, for example, the (M+7)-th and (M+8)-th frames F_M+7 and F_M+8 are holding periods during which the data voltage of the source data frame SDN charged in the display panel 200 is held.

The light luminance control part 170 provides a boosting signal to the light source part 400 during the charging period during which the data voltage of the interpolation data frame ID1 is charged in the display panel 200, and provides a normal signal to the light source part 400 during the holding period during which the data voltages of the first copy data frames cID1 and cID2 are charged in the display panel 200. The light luminance control part 170 provides the boosting signal to the light source part 400 during the charging period during which the data voltage of the source data frame SDN is charged in the display panel 200, and provides the normal signal to the light source part 400 during the holding period during which the data voltages of the second copy data frames cSDN1 and cSDN2 are charged in the display panel 200. The boosting signal has the low level LOL and blocks light from the display panel 200 during a first period T1 of the charging period, and has a boosting level BTL during a second period T2 of the charging period. The normal signal has a normal level NOL during a third period T3 of the holding period.

The light luminance control part 170 generates the normal signal based on the boosting signal. A luminance level of boosted light generated from the light source part 400 based on the boosting signal during the charging period is the same or substantially the same as a luminance level of the normal light generated from the light source part 400 based on the normal signal during the holding period. As a consequence, a luminance difference between images displayed during frames adjacent to each other may be prevented, and a driving voltage having the normal level NOL based on the normal signal is applied to the light source part 400 during the holding period so that the power consumption may be decreased.

However, when the source data frame SDN received during a present period is the same or substantially the same as the source data frame SDN-1 received during a previous period, the light luminance control part 170 determines that the source data frame SDN is a static image, and determines that levels of the boosting and normal signals corresponding to the source data frame SDN are the same or substantially the same as levels of the boosting and normal signals corresponding to the source data frame SDN-1. Therefore, when the static image is displayed on the display panel 200, a flicker may be prevented from occurring by a luminance difference between the sequential frame images.

According to an exemplary embodiment, the light source part 400 includes a first light-emitting block LB1, a second light-emitting block LB2, a third light-emitting block LB3 and a fourth light-emitting block LB4.

The light luminance control part 170 generates first, second, third and fourth driving signals LBS1, LBS2, LBS3 and LBS4 respectively based on the LC response rates LC1, LC2, LC3 and LC4 of first, second, third and fourth display blocks included in the display panel 200 and provides the first, second, third and fourth driving signals LBS1, LBS2, LBS3 and LBS4 to the first, second, third and fourth light-emitting blocks LB1, LB2, LB3 and LB4, respectively.

Referring to the first driving signal LBS 1, the first driving signal LBS1 has the boosting signal during a first charging period CHP1 during which the interpolation data frame ID1 or the source data frame SDN is charged in the first display block, and has the normal signal during a first holding period HOP1 during which two first copy data frames cID1 and cID2 or two second copy data frames cSDN1 and cSDN2 are charged in the first display block. The boosting signal has the low level LOL during the first period T1 of the first charging period CHP1 during which the first LC response rate LC1 is less than a threshold value, and the boosting level BTL during the second period T2 of the first charging period CHP1 during which the first LC response rate LC1 is more than or equal to the threshold value. The normal signal has the normal level NOL during the third period T3 of the first holding period HOP1.

A luminance level of boosted light generated from the first light-emitting block LB1 based on the boosting signal is the same or substantially the same as a luminance level of normal light generated from the first light-emitting block LB1 based on the normal signal. As a consequence, the boosting level BTL and the second period T2 are adjusted based on the normal level NOL and the third period T3. The normal level NOL and the third period T3 are adjusted based on the he boosting level BTL and the second period T2. The third period T3 is equal to or less than the first holding period HOP1.

As described above, the second driving signal LBS2 has the low level LOL during the first period T1 of a second charging period CHP2 during which the interpolation data frame ID1 or the source data frame SDN is charged in the second display block, and has the boosting level BTL during the second period T2 of the second charging period CHP2. The second driving signal LBS2 has the normal level NOL during a second holding period HOP2 during which two first copy data frames cID1 and cID2 or two second copy data frames cSDN1 and cSDN2 are charged in the second display block.

The third driving signal LBS3 has the low level LOL during the first period T1 of a third charging period CHP3 during which the interpolation data frame ID1 or the source data frame SDN is charged in the third display block, and has the boosting level BTL during the second period T2 of the third charging period CHP3. The third driving signal LBS3 has the normal level NOL during a third holding period HOP3 during which two first copy data frames cID1 and cID2 or two second copy data frames cSDN1 and cSDN2 are charged in the third display block.

The fourth driving signal LBS4 has the low level LOL during the first period T1 of a fourth charging period CHP4 during which the interpolation data frame ID1 or the source data frame SDN is charged in the fourth display block, and has the boosting level BTL during the second period T2 of the fourth charging period CHP4. The fourth driving signal LBS4 has the normal level NOL during a fourth holding period HOP4 during which two first copy data frames cID1 and cID2 or two second copy data frames cSDN1 and cSDN2 are charged in the fourth display block.

Therefore, the light source part 400 provides boosted light corresponding to a boosting luminance to the display panel 200 based on an LC response rate during the charging period during which the source data frame or the interpolation data frame is completely charged in the display panel 200, and provides normal light corresponding to a normal luminance to the display panel 200 during the holding period during which the copy data frame received from the repeating part 150 is charged in the display panel 200.

According to an exemplary embodiment, boosted light which increases power consumption is provided during the charging period during which the source data frame is completely charged in the display panel 200, and normal light which decreases power consumption is provided during the holding period during which the copy data frame is charged in the display panel 200. As a consequence, the power consumption of the display apparatus may be decreased.

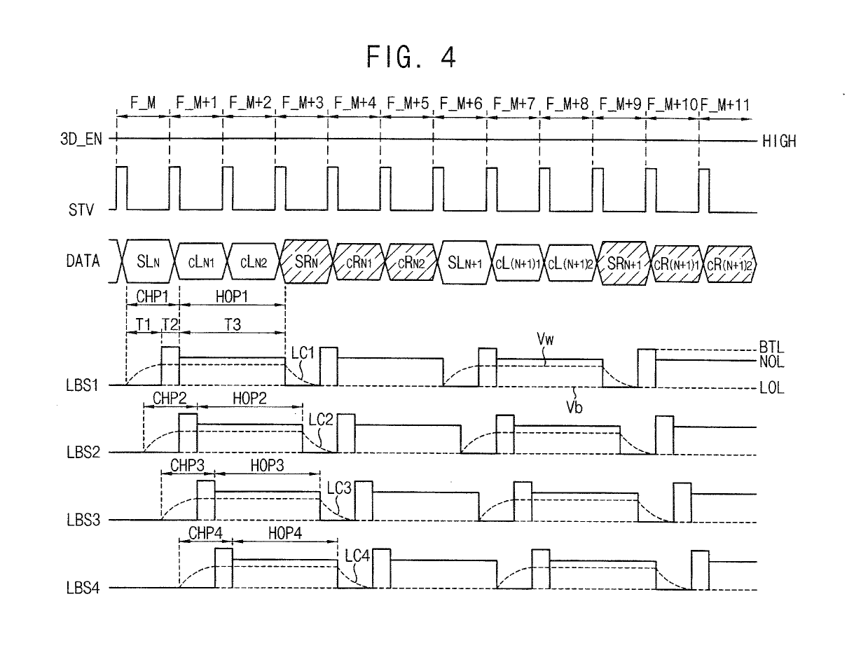

FIG. 4 is a timing diagram illustrating driving signals for describing a method of displaying a 3D image using a display apparatus according to an exemplary embodiment of the present.

Referring to FIGS. 1 and 4, a method of displaying a 3D image with a panel driving frequency of about 360 Hz is described.

The control part 110 receives the 3D enable signal 3D_EN of the high level HIGH and controls the main driving part 100 to process an operation of the display apparatus in the 3D image mode.

For example, the 3D processing part 130 processes received source data as 3D image data. The 3D processing part 130 divides source data into left-eye source data and right-eye source data, and scales the left-eye source data and the right-eye source data into a left-eye source data frame and a right-eye source data frame, respectively, corresponding to a resolution of the display panel 300. The 3D processing part 130 sequentially outputs the left-eye source data frame SLN and the right-eye source data frame SRN. According to an exemplary embodiment, the left-eye data frame SLN is referred to as a white data frame including white grayscale data corresponding to a white voltage Vw, and the right-eye source data frame SRN is referred to as a white data frame including a black data frame including black grayscale data corresponding to a black voltage Vb.

The repeating part 150 repeats each of the left-eye source data frame SLN and the right-eye source data frame SRN two times and outputs the left-eye source data frame SLN, two left-eye copy data frames cLN1 and cLN2, the right-eye source data frame SRN and two right-eye copy data frames cRN1 and cRN2.

According to an exemplary embodiment, a method of displaying a 3D image is performed by the display apparatus without the black inserting part 160. As a consequence, the panel driving part 300 receives the left-eye source data frame SLN, two left-eye copy data frames cLN1 and cLN2, the right-eye source data frame SRN and two right-eye copy data frames cRN1 and cRN2 outputted from the repeating part 150.

The panel driving part 300 provides the left-eye source data frame SLN, two left-eye copy data frames cLN1 and cLN2, the right-eye source data frame SRN and two right-eye copy data frames cRN1 and cRN2 to the display panel 200 based on a vertical stating signal STV with a panel driving frequency of about 360 Hz.

As shown in FIG. 4, the panel driving part 300 provides the left-eye source data frame SLN to the display panel 200 during an M-th frame F_M, provides the two left-eye copy data frames cLN1 and cLN2 to the display panel 200 during (M+1)-th and (M+2)-th frames F_M+1 and F_M+2, provides the right-eye source data frame SRN to the display panel 200 during an (M+3)-th frame F_M+3, and provides the two right-eye copy data frames cRN1 and cRN2 to the display panel 200 during (M+4)-th and (M+5)-th frames F_M+4 and F_M+5.

For example, the M-th frame F_M is a charging period during which a data voltage of the left-eye source data frame SLN is charged in the display panel 200. The (M+1)-th and (M+2)-th frames F_M+1 and F_M+2 are periods during which data voltages of two left-eye copy data frames cLN1 and cLN2 are charged in the display panel 200, for example, the (M+1)-th and (M+2)-th frames F_M+1 and F_M+2 are holding periods during which the data voltage of the left-eye source data frame SLN charged in the display panel 200 is held.

The (M+3)-th frame F_M+3 is a charging period during which a data voltage of the right-eye source data frame SRN is charged in the display panel 200. The (M+4)-th and (M+5)-th frames F_M+4 and F_M+5 are periods during which data voltages of two right-eye copy data frames cRN1 and cRN2 are charged in the display panel 200, for example, the (M+4)-th and (M+5)-th frames F_M+4 and F_M+5 are holding periods during which the data voltage of the right-eye source data frame SRN charged in the display panel 200 is held.

The light luminance control part 170 provides a boosting signal to the light source part 400 during the charging period during which the data voltage of the left-eye source data frame SLN is charged in the display panel 200, and provides a normal signal to the light source part 400 during the holding period during which the data voltage of the left-eye source data frame SLN is held in the display panel 200. The light luminance control part 170 provides the boosting signal to the light source part 400 during the charging period which the data voltage of the right-eye source data frame SRN is charged in the display panel 200, and provides the normal signal to the light source part 400 during the holding period during which the data voltage of the right-eye source data frame SRN is held in the display panel 200. The boosting signal has the low level LOL and blocks light from the display panel 200 during a first period T1 of the charging period, and has a boosting level BTL during a second period T2 of the charging period. The normal signal has a normal level NOL during a third period T3 of the holding period.

The light luminance control part 170 generates the normal signal based on the boosting signal. A luminance level of boosted light generated from the light source part 400 based on the boosting signal during the charging period is the same or substantially the same as a luminance level of normal light generated from the light source part 400 based on the normal signal during the holding period. As a consequence, a luminance difference between images displayed during the frames adjacent to each other may be prevented, and a driving voltage having the normal level NOL based on the normal signal is applied to the light source part 400 during the holding period so that power consumption may be decreased.

However, when the right-eye source data frame SRN or the left-eye source data frame SLN received during a present period is the same or substantially the same as the right-eye data frame SRN-1 or the left-eye source data frame SLN-1 received during a previous period, the light luminance control part 170 determines that the source data frame SDN is a static image, and determines that levels of the boosting and normal signals corresponding to the right-eye data frame SRN or the left-eye source data frame SLN are the same or substantially the same as levels of the boosting and normal signals corresponding to the right-eye data frame SRN-1 or the left-eye source data frame SLN-1.

According to an exemplary embodiment, the light source part 400 includes a first light-emitting block LB1, a second light-emitting block LB2, a third light-emitting block LB3 and a fourth light-emitting block LB4.

The light luminance control part 170 determines first, second, third and fourth driving signals LBS1, LBS2, LBS3 and LBS4 respectively based on the LC response rates LC1, LC2, LC3 and LC4 of first, second, third and fourth display blocks included in the display panel 200 and provides the first, second, third and fourth driving signals LBS1, LBS2, LBS3 and LBS4 to the first, second, third and fourth light-emitting blocks LB1, LB2, LB3 and LB4, respectively.

Referring to the first driving signal LBS1, the first driving signal LBS1 has the boosting signal during a first charging period CHP1 during which the right-eye data frame SRN or the left-eye source data frame SLN is charged in the first display block, and has the normal signal during a first holding period HOPI during which two left-eye copy data frames cLN1 and cLN2 or two right-eye copy data frames cRN1 and cRN2 are charged in the first display block. The boosting signal has the low level LOL during the first period T1 of the first charging period CHP1 during which a first LC response rate LC1 is less than a threshold value, and the boosting level BTL during the second period T2 of the first charging period CHP1 during which the first LC response rate LC1 is more than or equal to the threshold value. The normal signal has the normal level NOL during the third period T3 of the first holding period HOP1.

A luminance level of boosted light generated from the first light-emitting block LB1 based on the boosting signal is the same or substantially the same as a luminance level of normal light generated from the first light-emitting block LB1 based on the normal signal. As a consequence, the boosting level BTL and the second period T2 are adjusted based on the normal level NOL and the third period T3. The normal level NOL and the third period T3 are adjusted based on the boosting level BTL and the second period T2. The third period T3 is equal to or less than the first holding period HOP1.

As described above, the second driving signal LBS2 has the low level LOL during the first period T1 of a second charging period CHP2 during which the right-eye data frame SRN or the left-eye source data frame SLN is charged in the second display block and has the boosting level BTL during the second period T2 of the second charging period CHP2. The second driving signal LBS2 has the normal level NOL during a second holding period HOP2 during which two left-eye copy data frames cLN1 and cLN2 or two right-eye copy data frames cRN1 and cRN2 are charged in the second display block.

The third driving signal LBS3 has the low level LOL during the first period T1 of a third charging period CHP3 during which the right-eye data frame SRN or the left-eye source data frame SLN is charged in the third display block and has the boosting level BTL during the second period T2 of the third charging period CHP3. The third driving signal LBS3 has the normal level NOL during a third holding period HOP3 during which two left-eye copy data frames cLN1 and cLN2 or two right-eye copy data frames cRN1 and cRN2 are charged in the third display block.

The fourth driving signal LBS4 has the low level LOL during the first period T1 of a fourth charging period CHP4 during which the right-eye data frame SRN or the left-eye source data frame SLN is charged in the fourth display block and has the boosting level BTL during the second period T2 of the fourth charging period CHP4. The fourth driving signal LBS4 has the normal level NOL during a fourth holding period HOP4 during which two left-eye copy data frames cLN1 and cLN2 or two right-eye copy data frames cRN1 and cRN2 are charged in the fourth display block.

Therefore, the light source part 400 provides boosted light corresponding to a boosting luminance to the display panel 200 based on an LC response rate during the charging period during which the left-eye source data frame SLN or the right-eye source data frame SRN is completely charged in the display panel 200, and provides normal light corresponding to a normal luminance to the display panel 200 during the holding period during which the left-eye copy data frame or the right-eye copy data frame received from the repeating part 150 is charged in the display panel 200.

According to an exemplary embodiment, boosted light which increases power consumption is provided during the charging period during which the source data frame is completely charged in the display panel 200, and normal light which decreases power consumption is provided during the holding period during which the copy data frame is charged in the display panel 200. As a consequence, the power consumption of the display apparatus may be decreased. In the 3D image mode, boosted light is provided to the display panel 200 based on the LC response rate during a period during which the data voltage of the left-eye data frame or the right-eye data frame is completely charged in the display panel 200, so that crosstalk mixing the left-eye and right-eye images with each other may be prevented.

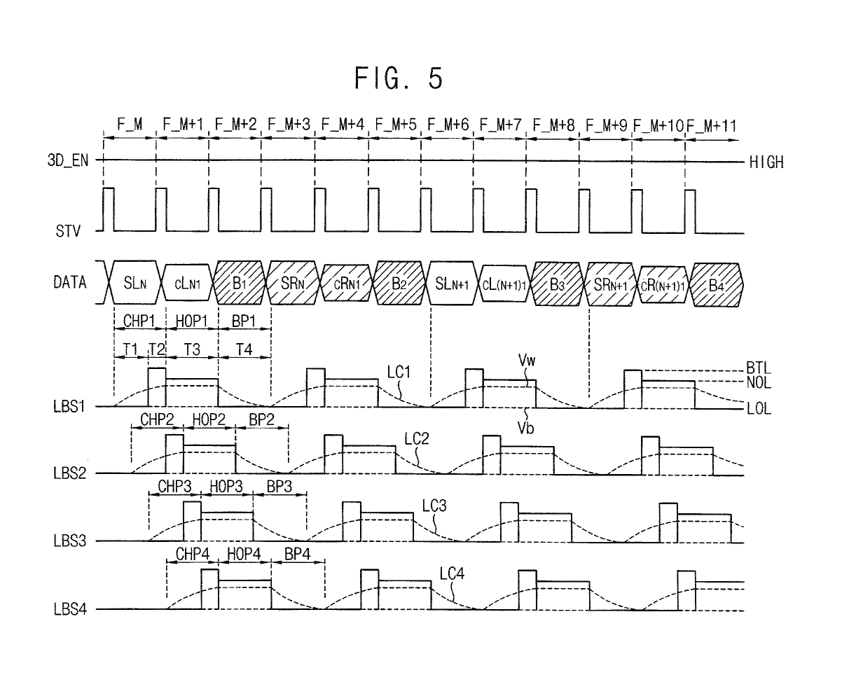

FIG. 5 is a timing diagram illustrating driving signals for describing a method of displaying a 3D image using a display apparatus according to an exemplary embodiment of the present invention.

Referring to FIGS. 1 and 5, a method of displaying a 3D image with a panel driving frequency of about 360 Hz is described.

The control part 110 receives the 3D enable signal 3D_EN of the high level HIGH and controls the main driving part 100 to process an operation of the display apparatus in the 3D image mode.

For example, the 3D processing part 130 processes received source data as 3D image data. The 3D processing part 130 divides the source data into left-eye source data and right-eye source data, and scales the left-eye source data and the right-eye source data into a left-eye source data frame and a right-eye source data frame, respectively, corresponding to a resolution of the display panel 300. The 3D processing part 130 sequentially outputs the left-eye source data frame SLN and the right-eye source data frame SRN. According to an exemplary embodiment, the left-eye data frame SLN is referred to as a white data frame including white grayscale data corresponding to a white voltage Vw, and the right-eye source data frame SRN is referred to as a white data frame including a black data frame including black grayscale data corresponding to a black voltage Vb.

The repeating part 150 repeats each of the left-eye source data frame SLN and the right-eye source data frame SRN two times and outputs the left-eye source data frame SLN, two left-eye copy data frames cLN1 and cLN2, the right-eye source data frame SRN and two right-eye copy data frames cRN1 and cRN2.

The black inserting part 160 receives the left-eye source data frame SLN, two left-eye copy data frames cLN1 and cLN2, the right-eye source data frame SRN and two right-eye copy data frames cRN1 and cRN2. The black inserting part 160 outputs the left-eye source data frame SLN, a first left-eye copy data frame cLN1, a black data frame B1 instead of a second left-eye copy data frame cLN2, the right-eye source data frame SRN, a first right-eye copy data frame cRN1 and a black data frame B2 instead of a second right-eye copy data frame cRN2.

The panel driving part 300 provides the left-eye source data frame SLN, the first left-eye copy data frame cLN1, the black data frame B1, the right-eye source data frame SRN, the first right-eye copy data frame cRN1 and the black data frame B2 to the display panel 200 based on a vertical stating signal STV with a panel driving frequency of about 360 Hz.

As shown in FIG. 5, the panel driving part 300 provides the left-eye source data frame SLN to the display panel 200 during an M-th frame F_M, provides the first left-eye copy data frame cLN1 to the display panel 200 during an (M+1)-th frame F_M+1, provides the black data frame B1 to the display panel 200 during an (M+2)-th frame F_M+2, provides the right-eye source data frame SRN to the display panel 200 during an (M+3)-th frame F_M+3, provides the first right-eye copy data frame cRN1 to the display panel 200 during an (M+4)-th frame F_M+4, and provides the black data frame B2 to the display panel 200 during an (M+5)-th frame F_M+5.

For example, the M-th frame F_M is a charging period during which a data voltage of the left-eye source data frame SLN is charged in the display panel 200. The (M+1)-th frame F_M+1 is a period during which a data voltage of the first left-eye copy data frame cLN1 is charged in the display panel 200, for example, the (M+1)-th frame F_M+1 is a holding period during which the data voltage of the left-eye source data frame SLN charged in the display panel 200 is held. The (M+2)-th frame F_M+2 is a black period during which the black data frame B1 is charged in the display panel 200, for example, the black period is a refresh period for refreshing the display panel 200.

The (M+3)-th frame F_M+3 is a charging period during which a data voltage of the right-eye source data frame SRN is charged in the display panel 200. The (M+4)-th frame F_M+4 is a period during which a data voltage of the first right-eye copy data frame cRN1 is charged in the display panel 200, for example, the (M+4)-th frame F_M+4 is a holding period during which the data voltage of the right-eye source data frame SRN charged in the display panel 200 is held. The (M+5)-th frame F_M+5 is a black period during which the black data frame B2 is charged in the display panel 200, for example, the black period is a refresh period for refreshing the display panel 200.

The light luminance control part 170 provides a boosting signal to the light source part 400 during the charging period during which the data voltage of the left-eye source data frame SLN is charged in the display panel 200, provides a normal signal to the light source part 400 during the holding period during which the data voltage of the left-eye source data frame SLN is held in the display panel 200, and provides an off signal to the light source part 400 during the black period during which the data voltage of the black data frame B1 is charged in the display panel 200.

The light luminance control part 170 provides the boosting signal to the light source part 400 during the charging period which the data voltage of the right-eye source data frame SRN is charged in the display panel 200, and provides the normal signal to the light source part 400 during the holding period during which the data voltage of the right-eye source data frame SRN is held in the display panel 200. The boosting signal has the low level LOL and blocks light from being provided to the display panel 200 during a first period T1 of the charging period, and has a boosting level BTL during a second period T2 of the charging period. The normal signal has a normal level NOL during a third period T3 of the holding period. The off signal has the low level LOL during a fourth period T4 of the black period.

The light luminance control part 170 generates the normal signal based on the boosting signal. A luminance level of boosted light generated from the light source part 400 based on the boosting signal during the charging period is the same or substantially the same as a luminance level of normal light generated from the light source part 400 based on the normal signal during the holding period. As a consequence, a luminance difference between images displayed during the frames adjacent to each other may be prevented, and a driving voltage having the normal level NOL based on the normal signal is applied to the light source part 400 during the holding period so that power consumption may be decreased.

However, when the right-eye source data frame SRN or the left-eye source data frame SLN received during a present period is the same or substantially the same as the right-eye source data frame SRN-1 or the left-eye source data frame SLN-1 received during a previous period, the light luminance control part 170 determines that the source data frame SDN is a static image, and determines that levels of the boosting and normal signals corresponding to the right-eye source data frame SRN or the left-eye source data frame SLN are the same or substantially the same as levels of the boosting and normal signals corresponding to the right-eye source data frame SRN-1 or the left-eye source data frame SLN-1.

According to an exemplary embodiment, the light source part 400 includes a first light-emitting block LB1, a second light-emitting block LB2, a third light-emitting block LB3 and a fourth light-emitting block LB4.

The light luminance control part 170 determines first, second, third and fourth driving signals LBS1, LBS2, LBS3 and LBS4 respectively based on LC response rates LC1, LC2, LC3 and LC4 of first, second, third and fourth display blocks included in the display panel 200 and provides the first, second, third and fourth driving signals LBS1, LBS2, LBS3 and LBS4 to the first, second, third and fourth light-emitting blocks LB1, LB2, LB3 and LB4, respectively.

Referring to the first driving signal LBS1, the first driving signal LBS1 has the boosting signal during a first charging period CHP1 during which the right-eye data frame SRN or the left-eye source data frame SLN is charged in the first display block, has the normal signal during a first holding period HOP1 during which the first left-eye copy data frame cLN1 or the first right-eye copy data frame cRN1 is charged in the first display block, and has the off signal during a first black period BP1 during which the black data frame B1 or B2 is charged in the first display block. The boosting signal has the low level LOL during the first period T1 of the first charging period CHP1 during which the first LC response rate LC1 is less than a threshold value, and the boosting level BTL during the second period T2 of the first charging period CHP1 during which the first LC response rate LC1 is more than or equal to the threshold value. The normal signal has the normal level NOL during the third period T3 of the first holding period HOP1. The off signal has the low level LOL during the fourth period T4 of the first black period BP1.

A luminance level of boosted light generated from the first light-emitting block LB1 based on the boosting signal is the same or substantially the same as a luminance level of normal light generated from the first light-emitting block LB1 based on the normal signal. As a consequence, the boosting level BTL and the second period T2 are adjusted based on the normal level NOL and the third period T3. The normal level NOL and the third period T3 are adjusted based on the he boosting level BTL and the second period T2. The third period T3 is equal to or less than the first holding period HOP1. The fourth period T4 is equal to or less than the first black period BP1.

As described above, the second driving signal LBS2 has the low level LOL during the first period T1 of a second charging period CHP2 during which the right-eye source data frame SRN or the left-eye source data frame SLN is charged in the second display block, and has the boosting level BTL during the second period T2 of the second charging period CHP2. The second driving signal LBS2 has the normal level NOL during a second holding period HOP2 during which the first left-eye copy data frame cLN1 or the first right-eye copy data frame cRN1 is charged in the second display block, and has the low level LOL during a second black period BP2 during which the black data frame B1 or B2 is charged in the second display block.

The third driving signal LBS3 has the low level LOL during the first period T1 of a third charging period CHP3 during which the right-eye source data frame SRN or the left-eye source data frame SLN is charged in the third display block, and has the boosting level BTL during the second period T2 of the third charging period CHP3. The third driving signal LBS3 has the normal level NOL during a third holding period HOP3 during which the first left-eye copy data frame cLN1 or the first right-eye copy data frame cRN1 is charged in the third display block, and has the low level LOL during a third black period BP3 during which the black data frame B1 or B2 is charged in the third display block.

The fourth driving signal LBS4 has the low level LOL during the first period T1 of a fourth charging period CHP4 during which the right-eye source data frame SRN or the left-eye source data frame SLN is charged in the fourth display block, and has the boosting level BTL during the second period T2 of the fourth charging period CHP4. The fourth driving signal LBS4 has the normal level NOL during a fourth holding period HOP4 during which the first left-eye copy data frame cLN1 or the first right-eye copy data frame cRN1 is charged in the fourth display block, and has the low level LOL during a fourth black period BP4 during which the black data frame B1 or B2 is charged in the fourth display block.

The light source part 400 provides boosted light corresponding to a boosting luminance to the display panel 200 based on the LC response rate during the charging period during which the left-eye source data frame SLN or the right-eye source data frame SRN is completely charged in the display panel 200, provides normal light corresponding to a normal luminance to the display panel 200 during the holding period during which the left-eye copy data frame or the right-eye copy data frame received from the repeating part 150 is charged in the display panel 200, and blocks light from being provided to the display panel 200 during the black period during which the black data frame received from the black inserting part 160 is charged in the display panel 200.

Therefore, boosted light which increases power consumption is provided during the charging period during which the source data frame is completely charged in the display panel 200, and normal light which decreases power consumption is provided during the holding period during which the copy data frame is charged in the display panel 200. As a consequence, the power consumption of the display apparatus may be decreased. In the 3D image mode, boosted light is provided to the display panel 200 based on the LC response rate during a period during which the data voltage of the left-eye data frame or the right-eye data frame is completely charged in the display panel 200, so that crosstalk mixing the left-eye and right-eye images with each other may be prevented. A black image is inserted between the left-eye image and the right-eye image so that crosstalk may be further prevented.

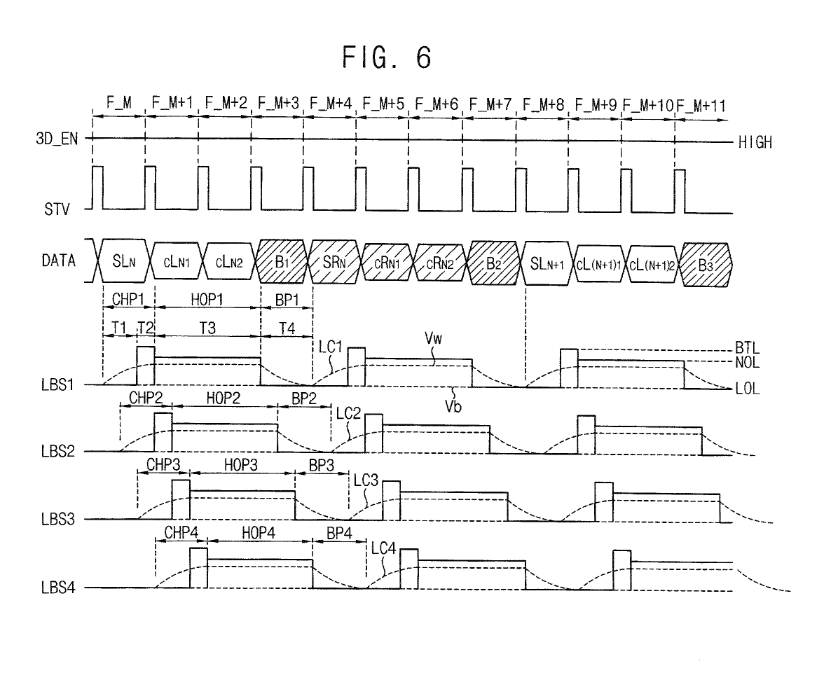

FIG. 6 is a timing diagram illustrating driving signals for describing a method of displaying a 3D image using a display apparatus according to an exemplary embodiment of the present.

Referring to FIGS. 1 and 6, a method of displaying a 3D image with a panel driving frequency of about 480 Hz is described.

The control part 110 receives the 3D enable signal 3D_EN of the high level HIGH and controls the main driving part 100 to process an operation of the display apparatus in the 3D image mode.

For example, the 3D processing part 130 processes received source data as 3D image data. The 3D processing part 130 divides the source data into left-eye source data and right-eye source data, and scales the left-eye source data and the right-eye source data into a left-eye source data frame and a right-eye source data frame, respectively, corresponding to a resolution of the display panel 300. The 3D processing part 130 sequentially outputs the left-eye source data frame SLN and the right-eye source data frame SRN. According to an exemplary embodiment, the left-eye data frame SLN is referred to as a white data frame including white grayscale data corresponding to a white voltage Vw and the right-eye source data frame SRN is referred to as a white data frame including a black data frame including black grayscale data corresponding to a black voltage Vb.

The repeating part 150 repeats each of the left-eye source data frame SLN and the right-eye source data frame SRN three times and outputs the left-eye source data frame SLN, three left-eye copy data frames cLN1, cLN2 and cLN3, the right-eye source data frame SRN and three right-eye copy data frames cRN1, cRN2 and cRN3.

The black inserting part 160 receives the left-eye source data frame SLN, three left-eye copy data frames cLN1, cLN2 and cLN3, the right-eye source data frame SRN and three right-eye copy data frames cRN1, cRN2 and cRN3. The black inserting part 160 outputs the left-eye source data frame SLN, first and second left-eye copy data frames cLN1 and cLN2, a black data frame B1 instead of a third left-eye copy data frame cLN3, the right-eye source data frame SRN, first and second right-eye copy data frames cRN1 and cRN2, and a black data frame B2 instead of a third right-eye copy data frame cRN3.

The panel driving part 300 provides the left-eye source data frame SLN, two left-eye copy data frames cLN1 and cLN2, the black data frame B1, the right-eye source data frame SRN, two right-eye copy data frames cRN1 and cRN2, and the black data frame B2 to the display panel 200 based on a vertical stating signal STV with a panel driving frequency of about 480 Hz.

As shown in FIG. 6, the panel driving part 300 provides the left-eye source data frame SLN to the display panel 200 during an M-th frame F_M, provides two left-eye copy data frames cLN1 and cLN2 to the display panel 200 during (M+1)-th and (M+2)-th frames F_M+1 and F_M+2, provides the black data frame B1 to the display panel 200 during an (M+3)-th frame F_M+3, provides the right-eye source data frame SRN to the display panel 200 during an (M+4)-th frame F_M+4, provides two right-eye copy data frames cRN1 and cRN2 to the display panel 200 during (M+5)-th and (M+6)-th frames F_M+5 and F_M+6, and provides the black data frame B2 to the display panel 200 during an (M+7)-th frame F_M+7.

For example, the M-th frame F_M is a charging period during which a data voltage of the left-eye source data frame SLN is charged in the display panel 200. The (M+1)-th and (M+2)-th frames F_M+1 and F_M+2 are periods during which data voltages of two left-eye copy data frames cLN1 and cLN2 are charged in the display panel 200, for example, the (M+1)-th and (M+2)-th frames F_M+1 and F_M+2 are holding periods during which the data voltage of the left-eye source data frame SLN charged in the display panel 200 is held. The (M+3)-th frame F_M+3 is a black period during which the black data frame B1 is charged in the display panel 200, for example, the black period is a refresh period for refreshing the display panel 200.

The (M+4)-th frame F_M+4 is a charging period during which a data voltage of the right-eye source data frame SRN is charged in the display panel 200. The (M+5)-th and (M+6)-th frames F_M+5 and F_M+6 are periods during which data voltages of two right-eye copy data frames cRN1 and cRN2 are charged in the display panel 200, for example, the (M+5)-th and (M+6)-th frames F_M+5 and F_M+6 are holding periods during which the data voltage of the right-eye source data frame SRN charged in the display panel 200 is held. The (M+7)-th frame F_M+7 is a black period during which the black data frame B2 is charged in the display panel 200, for example, the black period is a refresh period for refreshing the display panel 200.

The light luminance control part 170 provides a boosting signal to the light source part 400 during the charging period during which the data voltage of the left-eye source data frame SLN is charged in the display panel 200, provides a normal signal to the light source part 400 during the holding period during which the data voltage of the left-eye source data frame SLN is held in the display panel 200, and provides an off signal to the light source part 400 during the black period during which the data voltage of the black data frame B1 or B2 is charged in the display panel 200.

The light luminance control part 170 provides the boosting signal to the light source part 400 during the charging period during which the data voltage of the right-eye source data frame SRN is charged in the display panel 200, and provides the normal signal to the light source part 400 during the holding period during which the data voltage of the right-eye source data frame SRN is held in the display panel 200. The boosting signal has the low level LOL and blocks light from being provided to the display panel 200 during a first period T1 of the charging period, and has a boosting level BTL during a second period T2 of the charging period. The normal signal has a normal level NOL during a third period T3 of the holding period. The off signal has the low level LOL during a fourth period T4 of the black period.

The light luminance control part 170 generates the normal signal based on the boosting signal. A luminance level of boosted light generated from the light source part 400 based on the boosting signal during the charging period is the same or substantially the same as a luminance level of normal light generated from the light source part 400 based on the normal signal during the holding period. As a consequence, a luminance difference between images displayed during frames adjacent to each other may be prevented, and a driving voltage having the normal level NOL based on the normal signal is applied to the light source part 400 during the holding period so that power consumption may be decreased.

However, when the right-eye or left-eye source data frame SRN or SLN received during a present period is the same or substantially the same as the right-eye source data frame SRN-1 or the left-eye source data frame SLN-1 received during a previous period, the light luminance control part 170 determines that the source data frame SDN is a static image, and determines that levels of the boosting and normal signals corresponding to the right-eye source data frame SRN or the left-eye source data frame SLN are the same or substantially the same as levels of the boosting and normal signals corresponding to the right-eye source data frame SRN-1 or the left-eye source data frame SLN-1.

According to an exemplary embodiment, the light source part 400 includes a first light-emitting block LB1, a second light-emitting block LB2, a third light-emitting block LB3 and a fourth light-emitting block LB4.

The light luminance control part 170 determines first, second, third and fourth driving signals LBS1, LBS2, LBS3 and LBS4 respectively based on LC response rates LC1, LC2, LC3 and LC4 of the display panel 200 and provides the first, second, third and fourth driving signals LBS1, LBS2, LBS3 and LBS4 to the first, second, third and fourth light-emitting blocks LB1, LB2, LB3 and LB4, respectively.

Referring to the first driving signal LBS1, the first driving signal LBS1 has the boosting signal during a first charging period CHP1 during which the right-eye source data frame SRN or the left-eye source data frame SLN is charged in the first display block, has the normal signal during a first holding period HOPI during which two left-eye copy data frames cLN1 and cLN2 or two right-eye copy data frames cRN1 and cRN2 are charged in the first display block and has the off signal during a first black period BP1 during which the black data frame B1 or B2 is charged in the first display block. The boosting signal has the low level LOL during the first period T1 of the first charging period CHP1 during which the first LC response rate LC1 is less than a threshold value, and the boosting level BTL during the second period T2 of the first charging period CHP1 during which the first LC response rate LC1 is more than or equal to the threshold value. The normal signal has the normal level NOL during the third period T3 of the first holding period HOP1. The off signal has the low level LOL during the fourth period T4 of the first black period BP1.

A luminance level of boosted light generated from the first light-emitting block LB1 based on the boosting signal is the same or the substantially the same as a luminance level of normal light generated from the first light-emitting block LB1 based on the normal signal. As a consequence, the boosting level BTL and the second period T2 are adjusted based on the normal level NOL and the third period T3. The normal level NOL and the third period T3 are adjusted based on the boosting level BTL and the second period T2. The third period T3 is equal to or less than the first holding period HOP1. The fourth period T4 is equal to or less than the first black period BP1.

As described above, the second driving signal LBS2 has the low level LOL during the first period T1 of a second charging period CHP2 during which the right-eye source data frame SRN or the left-eye source data frame SLN is charged in the second display block, and has the boosting level BTL during the second period T2 of the second charging period CHP2. The second driving signal LBS2 has the normal level NOL during a second holding period HOP2 during which two left-eye copy data frames cLN1 and cLN2 or two right-eye copy data frames cRN1 and cRN2 are charged in the second display block, and has the low level LOL during a second black period BP2 during which the black data frame B1 or B2 is charged in the second display block.

The third driving signal LBS3 has the low level LOL during the first period T1 of a third charging period CHP3 during which the right-eye source data frame SRN or the left-eye source data frame SLN is charged in the third display block, and has the boosting level BTL during the second period T2 of the third charging period CHP3. The third driving signal LBS3 has the normal level NOL during a third holding period HOP3 during which two left-eye copy data frames cLN1 and cLN2 or two right-eye copy data frames cRN1 and cRN2 are charged in the third display block, and has the low level LOL during a third black period BP3 during which the black data frame B1 or B2 is charged in the third display block.

The fourth driving signal LBS4 has the low level LOL during the first period T1 of a fourth charging period CHP4 during which the right-eye source data frame SRN or the left-eye source data frame SLN is charged in the fourth display block, and has the boosting level BTL during the second period T2 of the fourth charging period CHP4. The fourth driving signal LBS4 has the normal level NOL during a fourth holding period HOP4 during which two left-eye copy data frames cLN1 and cLN2 or two right-eye copy data frames cRN1 and cRN2 are charged in the fourth display block, and has the low level LOL during a fourth black period BP4 during which the black data frame B1 or B2 is charged in the fourth display block.

The light source part 400 provides boosted light corresponding to a boosting luminance to the display panel 200 based on the LC response rate during the charging period during which the left-eye source data frame SLN or the right-eye source data frame SRN is completely charged in the display panel 200, provides normal light corresponding to a normal luminance to the display panel 200 during the holding period during which the left-eye copy data frame or the right-eye copy data frame received from the repeating part 150 is charged in the display panel 200, and blocks light from being provided to the display panel 200 during the black period during which the black data frame received from the black inserting part 160 is charged in the display panel 200.

Therefore, boosted light which increases power consumption is provided during the charging period during which the source data frame is completely charged in the display panel 200, and normal light which decreases power consumption is provided during the holding period during which the copy data frame is charged in the display panel 200. As a consequence, the power consumption of the display apparatus may be decreased. In the 3D image mode, boosted light is provided to the display panel 200 based on the LC response rate during a period during which the data voltage of the left-eye data frame or the right-eye data frame is completely charged in the display panel 200, so that crosstalk mixing the left-eye and right-eye images with each other may be prevented. According to an embodiment, a black image is inserted between the left-eye image and the right-eye image so that crosstalk may be further prevented.

The foregoing is illustrative of the embodiments of the present invention and is not to be construed as limiting thereof. Although a few exemplary embodiments of the present invention have been described, those skilled in the art will readily appreciate that many modifications are possible in the exemplary embodiments. Accordingly, all such modifications are intended to be included within the scope of the embodiments of the present invention as defined in the claims.

What is claimed is:

1. A method of displaying an image, the method comprising:
providing a source data frame and at least one copy data frame repeating the source data frame to a display panel; and
selectively providing boosted light of a first luminance level to the display panel during a first period and normal light of a second luminance level to the display panel during a second period based on the source data frame and the copy data frame, wherein the second luminance level is smaller than the first luminance level.

2. The method of claim 1, wherein the second period is longer than the first period.

3. The method of claim 1, wherein when the source data frame is the same or substantially the same as a previous source data frame received during a previous period, the first and second luminance levels are the same or substantially the same as luminance levels of previous boosted light and previous normal light provided to the display panel when an image corresponding to the previous source data frame is displayed on the display panel.

4. The method of claim 1, further comprising:
providing the boosted light to the display panel when a data voltage of the source data frame is charged; and
providing the normal light to the display panel when a data voltage of the at least one copy data frame is charged.

5. The method of claim 1, further comprising:
generating an interpolation data frame using a motion estimation and motion compensation algorithm based on the source data frame when the source data frame includes two-dimensional image data;
repeating each of the source data frame and the interpolation data frame and outputting the source data frame, at least one first copy data frame repeating the source data frame, the interpolation data frame, and at least one second copy data frame repeating the interpolation data frame;
providing the boosted light to the display panel when a data voltage of the source data frame or the interpolation data frame is charged; and
providing the normal light to the display panel when a data voltage of the first copy data frame or the second copy data frame is charged.

6. The method of claim 1, further comprising:
repeating each of left-eye and right-eye source data frames and outputting the left-eye source data frame, at least one left-eye copy data frame repeating the left-eye source data frame, the right-eye source data frame and at least one the right-eye copy data frame repeating the right-eye source data frame when the source data frame includes three-dimensional image data including the left-eye and right-eye source data frames;
providing the boosted light to the display panel when a data voltage of the left-eye data frame or the right-eye source data frame is charged; and
providing the normal light to the display panel when a data voltage of the left-eye data frame or the right-eye copy data frame is charged.

7. The method of claim 6, further comprising:
inserting a black data frame between the left-eye copy data frame and the right-eye source data frame; and
inserting the black data frame between the right-eye copy data frame and the left-eye source data frame.

8. The method of claim 7, further comprising:
blocking light from being provided to the display panel when a data voltage of the black data frame is charged.

9. The method of claim 1, further comprising:
sequentially providing a plurality of block light to a plurality of display blocks of the display panel, the block light being generated from a plurality of light-emitting blocks corresponding to the display blocks,
wherein a light-emitting block of the plurality of light-emitting blocks corresponding to a display block of the plurality of display blocks generates the boosted light when a data voltage of the source data frame is charged and generates the normal light when a data voltage of the copy data frame is charged.

10. The method of claim 1, wherein the first period is determined based on a response rate of the display panel.

11. The method of claim 1, wherein a luminance level of the display panel receiving the boosted light during the first period is the same or substantially the same as a luminance level of the display panel receiving the normal light during the second period.

12. A display apparatus comprising:
a display panel;
a main driving part providing a source data frame and at least one copy data frame repeating the source data frame to the display panel; and
a light source part selectively providing boosted light of a first luminance level to the display panel during a first period and normal light of a second luminance level to the display panel during a second period based on the source data frame and the copy data frame, wherein the second luminance level is smaller than the first luminance level.

13. The display apparatus of claim 12, wherein the second period is longer than the first period.

14. The display apparatus of claim 12, wherein the main driving part comprises:
a repeating part repeating the source data frame and outputting the at least one copy data frame; and
a light luminance control part providing the boosted light to the display panel when a data voltage of the source data frame is charged, and providing the normal light to the display panel when a data voltage of the at least one copy data frame is charged.

15. The display apparatus of claim 12, wherein when source data frame is the same or substantially the same as a previous source data frame received during a previous period, the light luminance control part provides the boosted light of the first luminance level and the normal light of the second luminance level to the display panel wherein the first and second luminance levels are the same or substantially the same as luminance levels of previous boosted light and previous normal light provided to the display panel when an image corresponding to the previous source data frame is displayed on the display panel.

16. The display apparatus of claim 12, wherein the main driving part further comprises an interpolating part generating an interpolation data frame using a motion estimation and motion compensation algorithm based on the source data frame,
wherein the repeating part repeats each of the source data frame and the interpolation data frame and outputs the source data frame, at least one first copy data frame repeating the source data frame, the interpolation data frame, and at least one second copy data frame repeating the interpolation data frame, and
the light luminance control part provides the boosted light to the display panel when a data voltage of the source data frame or the interpolation data frame is charged, and provides the normal light to the display panel when a data voltage of the first copy data frame or the second copy data frame is charged.

17. The display apparatus of claim 12, wherein the main driving part further comprises a three-dimensional processing part processing the source data frame and outputting a left-eye source data frame and a right-eye source data frame,
wherein the repeating part repeats each of the left-eye and right-eye source data frames and outputs the left-eye source data frame, at least one left-eye copy data frame repeating the left-eye source data frame, the right-eye source data frame and at least one the right-eye source data frame repeating the right-eye source data frame, and
the light luminance control part provides the boosted light to the display panel when a data voltage of the left-eye data frame or the right-eye source data frame is charged, and provides the normal light to the display panel when a data voltage of the left-eye data frame or the right-eye copy data frame is charged.

18. The display apparatus of claim 17, wherein the main driving part further comprises:
a black inserting part inserting a black data frame between the left-eye copy data frame and the right-eye source data frame, and inserting the black data frame between the right-eye copy data frame and the light-eye source data frame.

19. The display apparatus of claim 18, wherein the light luminance control part controls the light source part to block light from being provided to the display panel when a data voltage of the black data frame is charged.

20. The display apparatus of claim 12, wherein the light source part comprises a plurality of light-emitting blocks corresponding to a plurality of display blocks included in the display panel, and the light-emitting blocks sequentially provide a plurality of block light to the display blocks,
wherein a light-emitting block of the plurality of light-emitting blocks corresponding to a display block of the plurality of display blocks generates the boosted light when a data voltage of the source data frame is charged and generates the normal light when a data voltage of the copy data frame is charged.

21. The display apparatus of claim 12, wherein the first period is determined based on a response rate of the display panel.

22. The display apparatus of claim 12, wherein the light luminance control part determines the second period and the second luminance level, so that a luminance level of the display panel receiving the boosted light during the first period is the same or substantially the same as a luminance level of the display panel receiving the normal light during the second period.

23. A display apparatus comprising:
a display panel;
a main driving part providing a source data frame and at least one copy data frame repeating the source data frame to the display panel;
a light source part providing light to the display panel; and
a light luminance control part supplying a first signal to the light source part during a first period when a data voltage of the source data frame is charged and a second signal to the light source part during a second period when a data voltage of the copy data frame is charged, wherein the light source part generates first light based on the first signal during the first period and second light based on the second signal during the second period, wherein the second signal is lower in level than the first signal and determined based on the first signal.
